(19) United States
(12) Patent Application Publication
(10) Pub. No.: US 2010/0271159 A1
(43) Pub. Date: Oct. 28, 2010

(54) Electromagnetic Coil Design for Improved Thermal Performance

(75) Inventors: Alex Ka Tim Poon, San Ramon, CA (US); Masahiro Totsu, Kumakura (JP); Leonard Wai Fung Kho, San Francisco, CA (US); Derek Coon, Redwood City, CA (US); Gaurav Keswani, Fremont, CA (US)

Correspondence Address: TI Law Group, 2055 Junction Avenue, #205, San Jose, CA, 95131-2116, US

(73) Assignee: NIKON CORPORATION

(21) Appl. No.: 12/718,600

(22) Filed: Mar. 5, 2010

Related U.S. Application Data
(60) Provisional application No. 61/158,900, filed on Mar. 10, 2009.

(51) Int. Cl. H01F 5/00

(52) U.S. Cl. 335/299

(57) ABSTRACT

Methods and apparatus for improving the thermal performance of electromagnetic coils are disclosed. According to one aspect of the present invention, an electromagnetic actuator includes a core and a coil. The coil is formed form a conductor wire that includes a plurality of windings. The windings are arranged around the core, and include at least a first set of windings and a second set of windings. The first set of windings has a different geometry from the second set of windings.

### CROSS-REFERENCE TO RELATED APPLICATION

The instant application claims priority of U.S. Provisional Patent Application No. 61/158,900, filed Mar. 10, 2009, entitled “Electromagnetic Coil Design for Improved Thermal Performance,” which is incorporated herein by reference in its entirety.

### BACKGROUND OF THE INVENTION

1. Field of the Invention

The present invention relates generally to electromagnetic actuators. More particularly, the present invention relates to methods for improving the thermal performance of coils used in electromagnetic actuators.

2. Description of the Related Art

Electromagnetic coils are used in many applications, as for example applications in linear motors, rotary motors, transformers, and inductors. Standard coils are typically formed from conductor wire that is wound multiple turns around a central core.

Actuators which use electromagnetic coils generally emit unwanted heat. Heat that is generated due to joule heating in the coils often limits the electromagnetic performance of the coils. Such heat may also have an adverse impact on heat-sensitive components, e.g., sensors, which may be operating in the vicinity of the coils.

To compensate for the heat generated due to joule heating in coils, external cooling may be applied to the coils to effectively cool the coils. The cooling may be of a variety of different forms, and is typically applied to the outer surface of the coils to minimize damage due to heat when a relatively high current is applied to the coils. Cooling methods may include utilizing insulating materials and/or providing liquid cooling sources. Such cooling methods or forms may be effective in cooling the outer surfaces, e.g., or ends, of the coils, but are often unable to provide significant cooling to inner surfaces of the coils. As the bulk thermal conductivity of a coil is usually relatively low, the temperature of regions of the coil which are further away from a cooling source are generally higher than the temperature of regions of the coil which are closer to the cooling source. In general, regions of the coil which are away from the ends or outer surfaces of the coil are relatively difficult to cool, as such regions are often difficult to access.

### SUMMARY OF THE INVENTION

The present invention pertains to varying geometries of conductor wire used in coils and/or the amount of current that flows through various portions of coils in order to improve the thermal performance or electromagnetic actuators.

According to one aspect of the present invention, an electromagnetic actuator includes a coil as well as a core. The coil is formed form a conductor wire that includes a plurality of windings. The windings are arranged around the core, and include at least a first set of windings and a second set of windings. The first set of windings has a different geometry from the second set of windings. In one embodiment, the first set of windings is located at approximately a first outer section of the coil and the second set of windings is located at approximately a center section of the coil. In such an embodiment, the conductor wire of the first set of windings has a first cross-sectional area and the conductor wire of the second set of windings has a second cross-sectional area that is larger than the first cross-sectional area.

According to another aspect of the present invention, an electromagnetic actuator includes a core, a current input, and a coil. The current input provides an overall current flow. The coil is formed form a conductor wire that includes a plurality of windings arranged around the core. The windings include at least a first set of windings and a second set of windings. The overall current flow flows through the coil such that a first amount of heat is generated in the first set of windings and a second amount of heat is generated in the second set of windings. The first amount of heat generated per unit volume in the first set of windings is greater than the second amount of heat generated per unit volume in the second set of windings. In one embodiment, the second set of windings includes a first sub-section and a second sub-section connected substantially in parallel. The first set of windings is coupled to the first sub-section and to the second sub-section such that a first amount of the overall current flow flows from the first set of windings into the first sub-section and a second amount of the overall current flow flows into the second sub-section substantially simultaneously.

In accordance with still another aspect of the present invention, a method for operating an electromagnetic actuator which includes a coil having at least a first section and a second section includes providing a current to the coil. Providing the current to the coil causes a first amount of heat to be generated in the first section and a second amount of heat to be generated in the second section. The second amount of heat is less than the first amount of heat, when measured per unit volume in the first and second sections, respectively. The method also includes cooling the first section. Cooling the first section includes removing at least some of the first amount of heat.

Other aspects of the present invention will become apparent from the following detailed description taken in conjunction with the accompanying drawings which illustrate, by way of example, the principles of some embodiments of the present invention.

### BRIEF DESCRIPTION OF THE DRAWINGS

The invention will be readily understood by the following detailed description in conjunction with the accompanying drawings, in which:

FIG. 1 is a block diagram representation of an electromagnetic coil with an overall conductor wire arrangement of different geometries in accordance with an embodiment of the present invention.

FIG. 2A is a side-view representation of an electromagnetic coil with conductor wires of different thicknesses, e.g., diameters, in accordance with an embodiment of the present invention.

FIG. 2B is a cross-sectional side-view representation of an electromagnetic coil with conductor wires of different thicknesses, e.g., electromagnetic coil 200 of FIG. 2A, in accordance with an embodiment of the present invention.

FIG. 3 is a diagrammatic representation of a conductor wire with two different geometries in accordance with an embodiment of the present invention.

FIG. 4 is a diagrammatic representation of a current flow through a coil with an overall conductor wire that has different geometries in accordance with an embodiment of the present invention.

FIG. 5 is a block diagram representation of an electromagnetic coil with conductor wires of more than two different geometries in accordance with an embodiment of the present invention.

FIG. 6 is a representation of a coil formed from an overall conductor wire that has different geometries in accordance with an embodiment of the present invention.

FIG. 7 is a diagrammatic representation of an electromagnetic coil with an overall conductor wire through which varying amounts of current flow in accordance with an embodiment of the present invention.

FIG. 8 is a block diagram representation of current flow through an electromagnetic coil in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1004 of FIG. 10, in accordance with an embodiment of the present invention.

FIG. 12A is a diagrammatic perspective representation of a coil in accordance with an embodiment of the present invention.

FIG. 12B is a diagrammatic cross-sectional representation of a coil, e.g., coil 1270 of FIG. 12A, in which a flat wire is present in approximately a center of the coil in accordance with an embodiment of the present invention.

FIG. 12C a diagrammatic cross-sectional representation of a coil, e.g., coil 1270 of FIG. 12A, in which a plurality of flat wires is present in accordance with one embodiment of the present invention.

FIG. 12D a diagrammatic cross-sectional representation of a coil, e.g., coil 1270 of FIG. 12A, in which a plurality of flat wires is present in accordance with another embodiment of the present invention.

FIG. 13A is a diagrammatic cross-sectional representation of a coil in which a flat wire is present in a vertical orientation in approximately a center of the coil in accordance with an embodiment of the present invention.

FIG. 13B is a diagrammatic cross-sectional representation of a coil in which a plurality of flat wires in a vertical orientation is present in accordance with one embodiment of the present invention.

FIG. 13C is a diagrammatic cross-sectional representation of a coil in which a plurality of flat wires in a stacked vertical orientation is present in accordance with one embodiment of the present invention.

### DETAILED DESCRIPTION OF THE INVENTION

Example embodiments of the present invention are discussed below with reference to the various figures. However, those skilled in the art will readily appreciate that the detailed description given herein with respect to these figures is for explanatory purposes, as the invention extends beyond these embodiments.

In general, regions or sections of a coil that are not outer surfaces of the coil are more difficult to cool as such regions are difficult to access. However, electromagnetic coils typically generate substantially the same amount of heat in all regions. Thus, when a coil generates heat, while the outer surfaces of the coil may be cooled to a lower temperature, the center of the coil may remain, more generally, at a relatively higher temperature.

To effectively prevent a center of a coil from being damaged due to a relatively high temperature or, more generally, a region of a coil that is not near an outer surface of the coil, a coil may be configured such that more heat is generated at and/or near outer surfaces of the coil and less heat is generated away from the outer surfaces of the coil. By way of example, the geometry of a conductor wire and/or current flow through a coil may be altered such that less heat is generated away from the outer surfaces of the coil. Hence, more heat is generated at and/or near outer surfaces of the coil where cooling is generally effective, and less heat is generated away from the outer surfaces of the coil where cooling is often less effective. Generating less heat near a center region of a coil may serve to reduce the need to provide cooling, e.g., external cooling, in an effort to cool the center region of the coil.

In one embodiment, the geometry of an overall conductor wire that forms a coil may be arranged such that the conductor wire is thicker and has a taller cross-section near a center region of the coil than at and/or near the outer surfaces, e.g., top and bottom regions, of the coil. The conductor wire at and/or near the outer surfaces of the coil is, thus, thinner and has a smaller cross-section. The thicker wire, which may be wire with a larger cross-sectional area, generates less heat than the thinner wire, as the resistance per unit lengths of such wire is generally relatively low. Hence, the wire used at and/or near the outer surfaces of the coil generates more heat per unit length than the wire used at the center region of the coil for substantially the same electrical current flowing through the wire. The heat at and/or near the outer surfaces of the coil may be substantially removed using external cooling methods.

In another embodiment, current may be provided to a coil which is composed of a substantially single type of conductor wire such that different regions of the coil have a different amount of electrical current flowing therethrough. The amounts of electrical current provided to different regions of the coil may be adjusted such that more heat is generated at and/or near outer surfaces of the coil, and less heat is generated at a center region of the coil.

By substantially redistributing generated heat in a coil volume such that more heat is effectively generated in the regions of a coil that are easier to cool, regions of the coil that are more difficult to cool are less likely to need significant cooling. That is, the need to apply an external cooling medium to center regions of a coil may be reduced when less heat is generated in the center regions than in the outer regions of a coil.

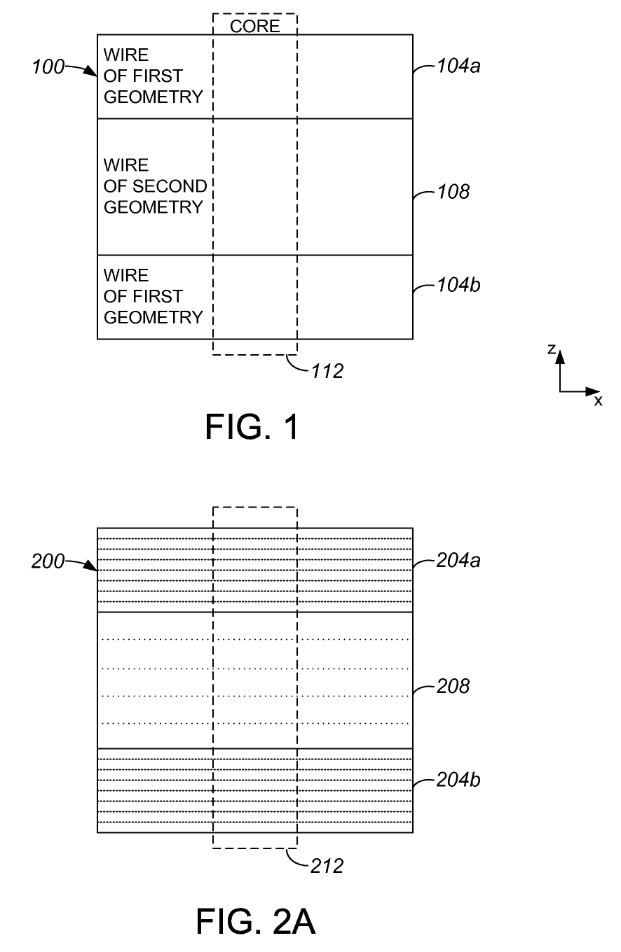

Referring initially to FIG. 1, an electromagnetic coil with an overall conductor wire arrangement of different geometries will be described in accordance with an embodiment of the present invention. In general, although an overall conductor wire may effectively include any number of different geometries, an overall conductor wire which includes two different geometries will be described for ease of illustration. An overall conductor wire 100 that forms a coil includes wire of a first geometry 104a, wire of first geometry 104b, and wire of a second geometry 108. As shown, wires of first geometry 104a, 104b are located at outer regions of the coil, whereas wire of second geometry 108 is located at an approximately center region of the coil. Overall conductor wire 100 effectively wraps around or winds around a core 112 to substantially form a coil.

Wires of first geometry 104a, 104b are generally thinner than wire of second geometry 108. In one embodiment, wires of first geometry 104a, 104b have a cross-section that is of substantially the same shape as the cross-section of wire of second geometry 108, but have a smaller cross-sectional area than wire of second geometry 108. For example, if the cross-sections of wires of first geometry 104a, 104b and wire of second geometry 108 are approximately circularly shaped, then the diameter of wires of first geometry 104a, 104b may be smaller than the diameter of wire of second geometry 108. It should be appreciated, however, the shape of the cross-sections of wires of first geometry 104a, 104b may be different from the shape of the cross-sections of wires of second geometry 108.

In one embodiment, wire of second geometry 108 may be between approximately two times and approximately three times thicker than wires of first geometry 104a, 104b, although the ratio of thicknesses may generally vary widely. When wire of second geometry 108 has a larger cross-sectional area than wires of first geometry 104a, 104b, there may be fewer windings of wire of second geometry 108 than of wires of first geometry 104a, 104b. However, because the magnetic properties associated with the coil may be affected by the total number of windings associated with overall conductor wire 100, the number of windings of wire of second geometry 108 may be increased substantially by decreasing the size of the cross-sectional area of wires of first geometry 104a, 104b. As such, wires of first geometry 104a, 104b may be thinner than needed or otherwise desired, in order to provide more windings of wire of second geometry 108. Generally, substantially maximizing a total number of windings or turns in overall conductor wire 100 allows magnetic properties associated with overall conductor wire 100 and, hence, a coil to be improved.

The amount of wire of first geometry 104a and the amount of wire of first geometry 104b included in overall conductor wire 100, as compared with the amount of wire of second geometry 108, may generally vary widely. In other words, the ratio of wire of first geometry 104a to wire of second geometry 108, and the ratio of wire of second geometry 108 to wire of first geometry 104b, may vary depending upon a variety of different factors. Such factors may include, but are not limited to including, the strength of a cooling medium used to provide external cooling, the amount of current provided to overall conductor wire 100, and/or the total number of turns of wires in the coil. In one embodiment, a ratio of wire of first geometry 104a to wire of second geometry 108 to wire of first geometry 104b may be approximately 1:4:1.

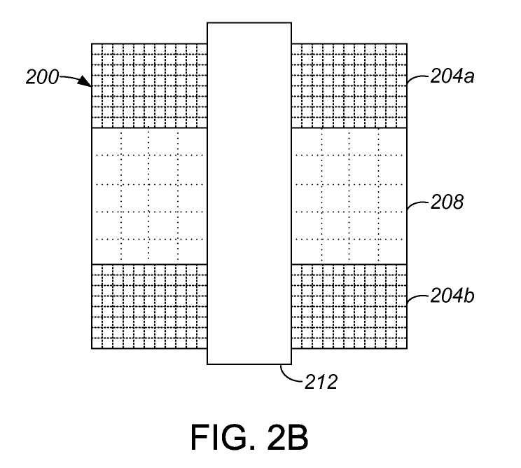

With reference to FIGS. 2A and 2B, an overall conductor wire with wire sections of different thicknesses, e.g., diameters, will be described in accordance with an embodiment of the present invention. FIG. 2A is a side-view representation of an electromagnetic coil with an overall conductor wire that includes wire sections of different thicknesses, and FIG. 2B is a cross-sectional side-view representation of the electromagnetic coil with the overall conductor wire. An overall conductor wire 200 includes sections of thinner wire 204a and a section of thicker wire 208 that are substantially connected and wound around a core 212. More generally, conductor wire 200 is formed from sections which have different geometries. Section of thicker wire 208 is generally a center region of a coil formed using overall conductor wire 200, while sections of thinner wire 204a, 204b are outer regions of the coil.

In general, overall conductor wire 200 is wound around core 212 such that adjacent turns are substantially in contact with each other. That is, adjacent windings of overall conductor wire 200 are such that there is effectively no gap or spacing therebetween.

Sections 204a, 204b are effectively attached to section 208 such that overall conductor wire 200 is continuous. Although overall conductor wire 200 may be formed from a substantially single piece of extruded wire, overall conductor wire 200 may instead be formed by coupling separate sections 204a, 204b to section 208. The coupling may be accomplished using any suitable method, e.g., soldering.

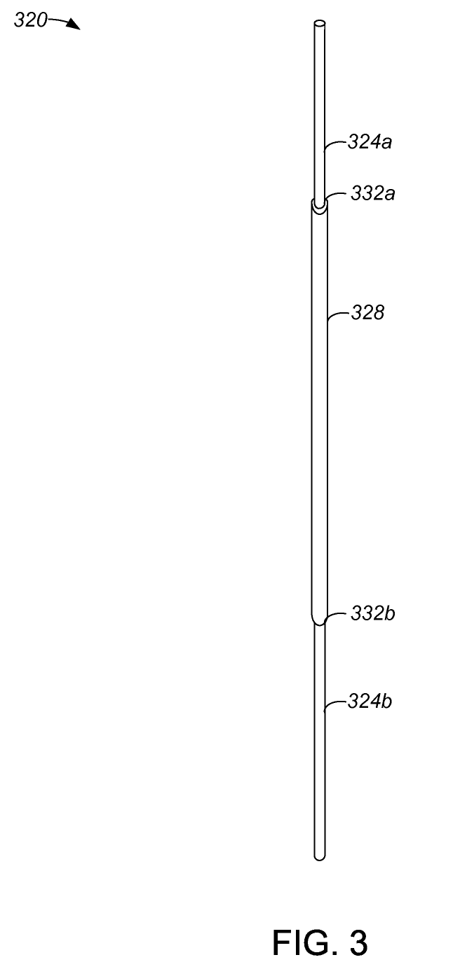

FIG. 3 is a diagrammatic representation of an overall conductor wire with a plurality of different geometries in accordance with an embodiment of the present invention. An overall conductor wire 320 includes three sections 324a, 324b, 328. It should be appreciated that although three sections 324a, 324b, 328 are shown, overall conductor wire 320 may include more than three sections. Sections 324a, 324b have substantially the same geometry, e.g., have approximately the same cross-sectional shape and cross-sectional area. Section 328 has a different geometry than sections 324a, 324b. In the described embodiment, section 328 has approximately the same cross-sectional shape as sections 324a, 324b, but has a larger cross-sectional area. Generally, however, both the cross-sectional shape and the cross-sectional area of section 328 may differ from those of sections 324a, 324b.

Section 324a is attached to section 328 at a point of attachment 332a, and section 324b is attached to section 328 at a point of attachment 332b. Points of attachment 332a, 332b may be solder joints, or points at which sections 324a, 324b are soldered or otherwise coupled to section 328.

Overall conductor wire 320 may be formed from any suitable material. Suitable materials include, but are not limited to including, copper. For example, sections 324a, 324b, 328 may be formed from substantially solid copper wire.

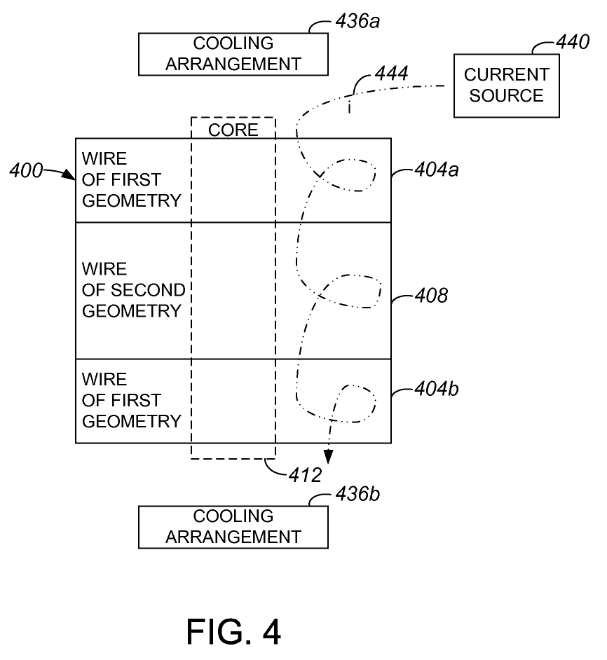

When current flows through a coil that includes sections with different geometries, the amount of heat generated in the different sections may vary. As previously mentioned, a coil may be arranged such that less heat is typically generated at a center section of a coil than at outer sections of the coil. FIG. 4 is a diagrammatic representation of a current flow through a coil with an overall conductor wire that has different geometries in accordance with an embodiment of the present invention. A coil or an overall conductor wire 400 that is wound around a core 412 includes wires of a first geometry 404a, 404b which are located at substantially outer regions or surfaces of coil 400. Coil 400 also includes a wire of a second geometry 408 which is located substantially at a center region of coil 400.

Wires of first geometry 404a, 404b are typically selected such that more heat per unit length is generated by wires of first geometry 404a, 404b than by wires of second geometry 408. When wires of first geometry 404a, 404b have a smaller cross-sectional area than wire of second geometry 408, then more heat per unit length is typically generated by wires of first geometry 404a, 404b.

Cooling arrangements 436a, 436b are positioned such that cooling arrangements 436a, 436b may provide cooling to wires of first geometry 404a, 404b. Although cooling arrangements 436a, 436b are shown as being substantially separate cooling arrangements, it should be appreciated that cooling arrangements 436a, 436b may instead be a part of a substantially single, overall cooling arrangement.

A current source 440 provides a current 444 to coil 400. As current 444 flows or otherwise passes through turns (not shown) in coil 400, heat is generated. As current 444 is substantially the same throughout coil conductor 400 due to the geometry of coil 400, less heat is generated per unit length by wire of second geometry 408 than by wire of first geometry 404a, 404b. Hence, more heat is generated at outer regions of coil 400 than at a center region of coil 400. The heat generated at outer regions of coil 400 may be substantially removed through cooling arrangement 436a, 436b.

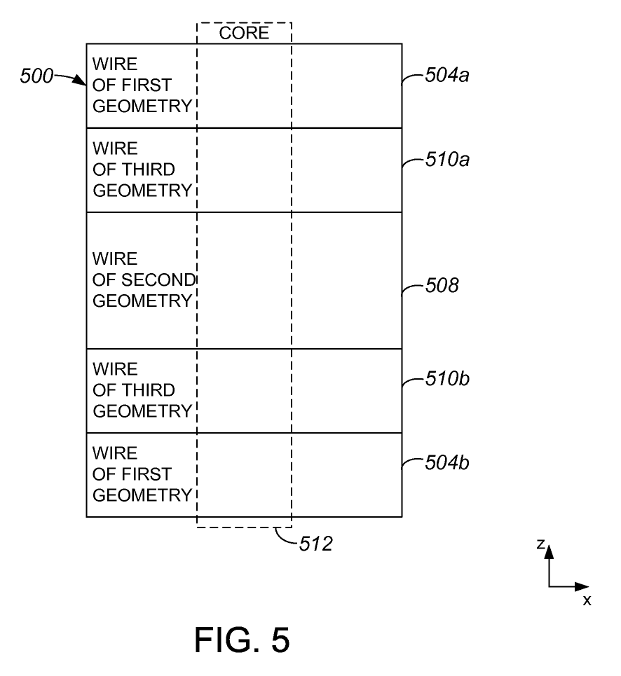

A coil may include more than two different geometries of conductor wire. For example, a coil may include one geometry at outer regions of the coil, another geometry at a center region of the coil, and still another geometry at regions between the outer regions and the center region. FIG. 5 is a block diagram representation of an electromagnetic coil with conductor wires of more than two different geometries in accordance with an embodiment of the present invention. A coil 500, which is formed from an overall conductor wire, is wound around a core 512. Outer regions of coil 500 are formed from wire of a first geometry 504a, 504b, and a substantially center region of coil 500 is formed from wire of a second geometry 508. “Intermediate” regions of coil 500, or regions of coil 500 located between outer regions and a center region, are formed from wire of a third geometry 510a, 510b. In the described embodiment, wires of first geometry 504a, 504b may have a relatively small cross-sectional area, wire of second geometry 508 may have a relatively large cross-sectional area, and wires of third geometry 510a, 510b may have a cross-sectional area that is of a size that is between that of wires of first geometry 504a, 504b and wire of second geometry 508.

In coil 500, the amount of heat generated by wires of first geometry 504a, 504b is higher than the amount of heat generated by wires of third geometry 510a, 510b. The amount of heat generated by wires of third geometry 510a, 510b, in turn, is higher than the amount of heat generated by wire of second geometry 508. When describing one amount of heat as being “higher” than another amount of heat, it should be appreciated that the amounts of heat generally apply to heat generated per unit volume in wires.

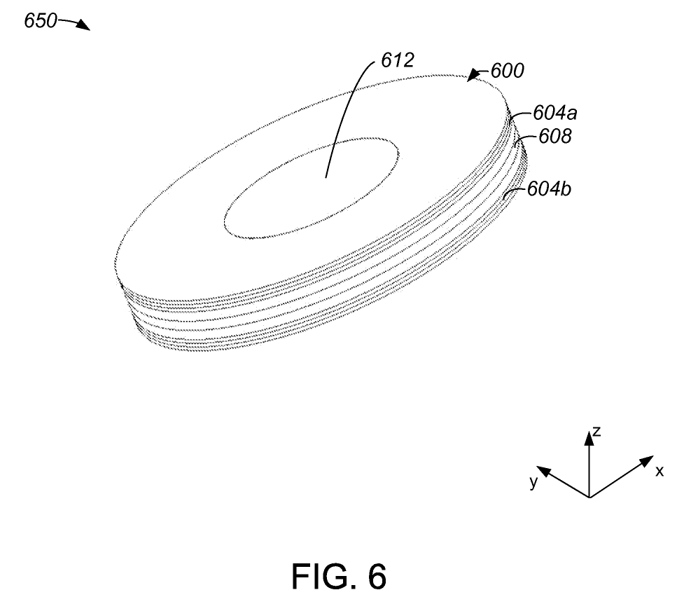

A coil with different geometries is generally wound around a core to form an assembly that may be used in an actuator, e.g., a linear motor or a rotary motor. FIG. 6 is a representation of a coil formed from an overall conductor wire that has different geometries in accordance with an embodiment of the present invention. An assembly 650 includes a coil 600 that is wound around a core 612. Coil 600 includes sections of conductor wire 604a, 604b which are configured to produce a larger amount of heat than a section of conductor wire 608 which is effectively “sandwiched” between sections of conductor wire 604a, 604b. In one embodiment, the geometry of coil 600 is such that a cross-sectional area of sections of conductor wire 604a, 604b is smaller than a cross-sectional area or section of conductor wire 608.

The number of turns or windings associated with coil 600 and, hence, section of conductor wire 608 and sections of conductor wire 604a, 604b, may vary. It should be appreciated, however, that the number of turns in section of conductor wire 608 may be substantially equal to or different from the total number of turns in sections of conductor wire 604a, 604b.

In lieu of altering the geometry of the conductor wire of a coil in order to effectively redistribute heat generated in a coil volume, distribution of current inside the coil may instead be altered to effectively redistribute heat generated in the coil volume. That is, the amount of current in a coil may be varied such that different sections of the coil have different amounts of current flowing therethrough. As will be understood by those skilled in the art, an overall conductor wire that forms a coil may include sub-sections of wire that are joined together using a series connection. A substantially constant amount of current may flow through such sub-sections of wire. By joining some of the sub-sections of wire used in an overall conductor wire together using a split, e.g., parallel, connection, the amount of current provided to those sub-sections of wire may be reduced. As a result, the heat generated in such sub-sections of wire may be reduced.

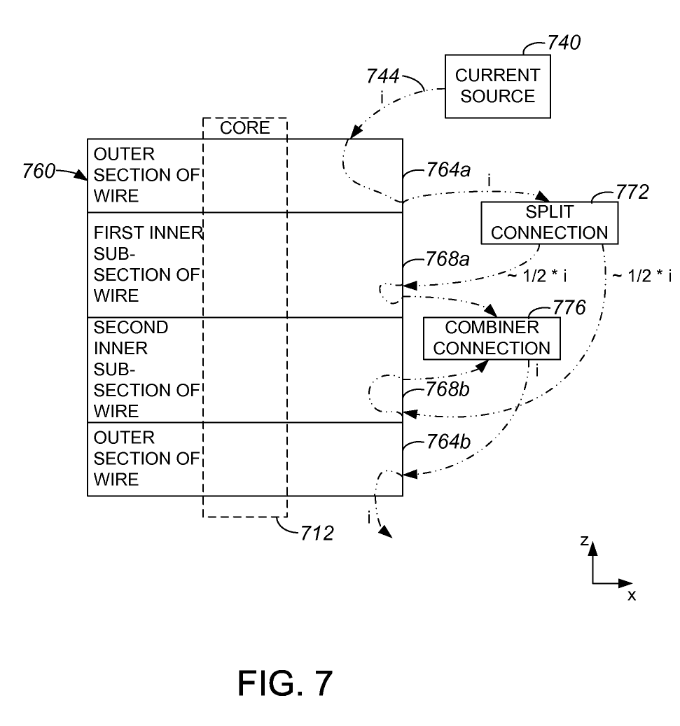

FIG. 7 is a diagrammatic representation of an electromagnetic coil with an overall conductor wire through which varying amounts of current flow in accordance with an embodiment of the present invention. A coil 760, which is formed from an overall conductor wire, is wound around a core 712. Coil 760 is composed of outer sections of wire 764a, 764b, and inner sub-sections of wire 768a, 768b. Inner sub-sections of wire 768a, 768b are located at a center region of coil 760.

Outer section of wire 764a is coupled to both first inner sub-section of wire 768a and second inner sub-section of wire 768b. A split connection 772 couples an end of outer section of wire 764a to both first inner sub-section of wire 768a and second inner sub-section of wire 768b. A combiner connection 776 couples both first inner sub-section of wire 768a and second inner sub-section of wire 768b to an end of outer section of wire 764b. As a result, first inner sub-section of wire 768a and second inner subsection of wire 768b are effectively in a parallel connection with each other, and substantially in series with outer section of wire 764a and outer section of wire 764b.

A current source 740 provides a current 744 which is arranged to flow through coil 760. Current 744 has a value ‘i’ when flowing through outer section of wire 764a. Hence, current which flows through outer section of wire 764a has approximately the value ‘i.’ When current 744 flows through split connection 772, current 744 has a value of approximately one-half of ‘i’ when flowing through first inner sub-section of wire 768a and substantially simultaneously through second inner sub-section of wire 768b. As current 744 of the value of approximately one-half of ‘i’ flows from first inner sub-section of wire 768a and second inner sub-section of wire 768b through combiner 776, current 744 once again has the value ‘i.’ Therefore, current 744 flowing through outer section of wire 764b has the value ‘i.’

As the amount of current 744 flowing through first inner sub-section of wire 768a and second inner sub-section of wire 768b has approximately half the value of current 744 flowing through outer sections of wire 764a, 764b, less heat is generated in first inner sub-section of wire 768a and second inner sub-section of wire 768b than in outer sections of wire 764a, 764b. That is, more heat is generated in easier to cool ends of coil 700 than near a center region of coil 700.

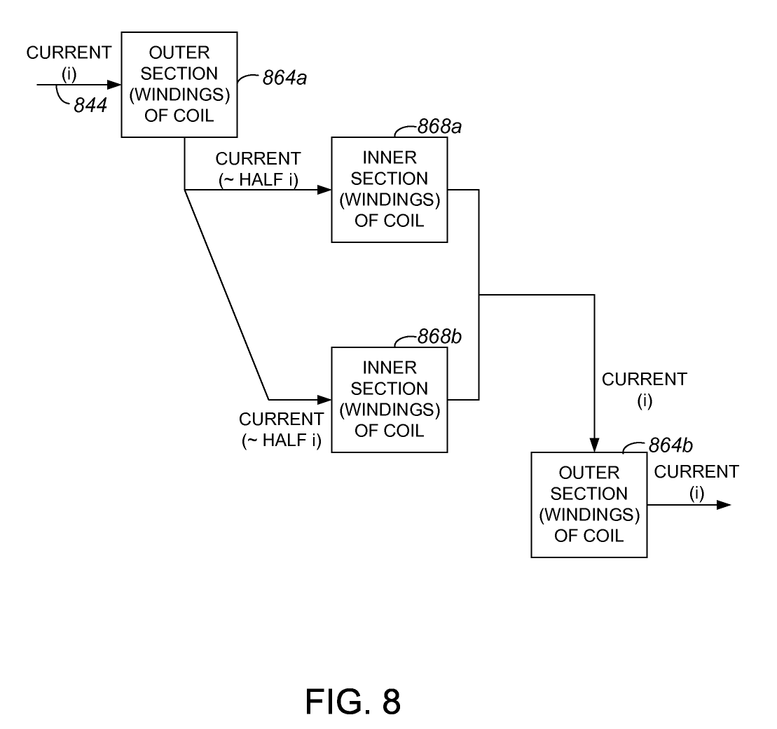

Referring next to FIG. 8, the flow of current through an electromagnetic coil which includes windings that are connected in parallel will be described in accordance with an embodiment of the present invention. Current 844 is provided to an outer section or windings of a coil 864a, e.g., to a top layer of windings. When current 844 flows out of outer windings of coil 864a, current 844 is effectively split such that approximately half of current 844 is provided to inner windings of coil 868a and approximately half of current 844 is provided to inner windings of coil 868b. Once current 844 flows through inner windings of coil 868a, 868b, current 844 is “unsplit” or otherwise summed back together such that approximately the full amount of current 844 is provided to outer windings of coil 864b, e.g., to a bottom layer of windings.

In some embodiments, a coil, e.g., a coil that is used in a linear motor, may be arranged to include at least one flat wire that allows heat to be redistributed with respect to the coil. By placing the flat wire near a center region of the coil, heat from the hottest region of the coil, e.g., an approximate center of the coil, may be substantially redistributed or otherwise dispersed within the coil. The redistribution of heat within a coil may result in a peak temperature inside the coil being reduced when current passes through the coil.

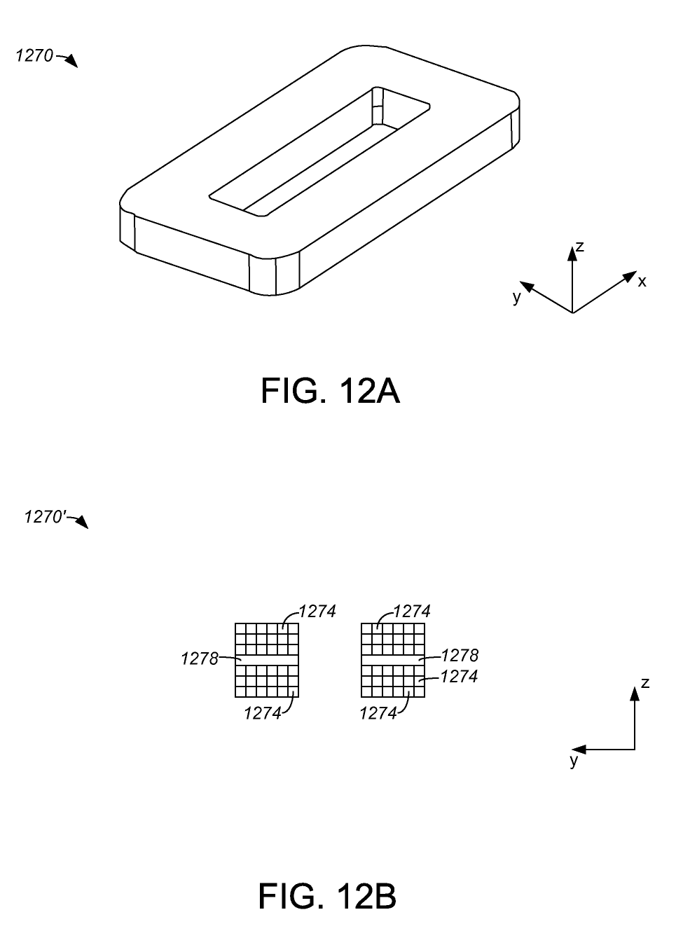

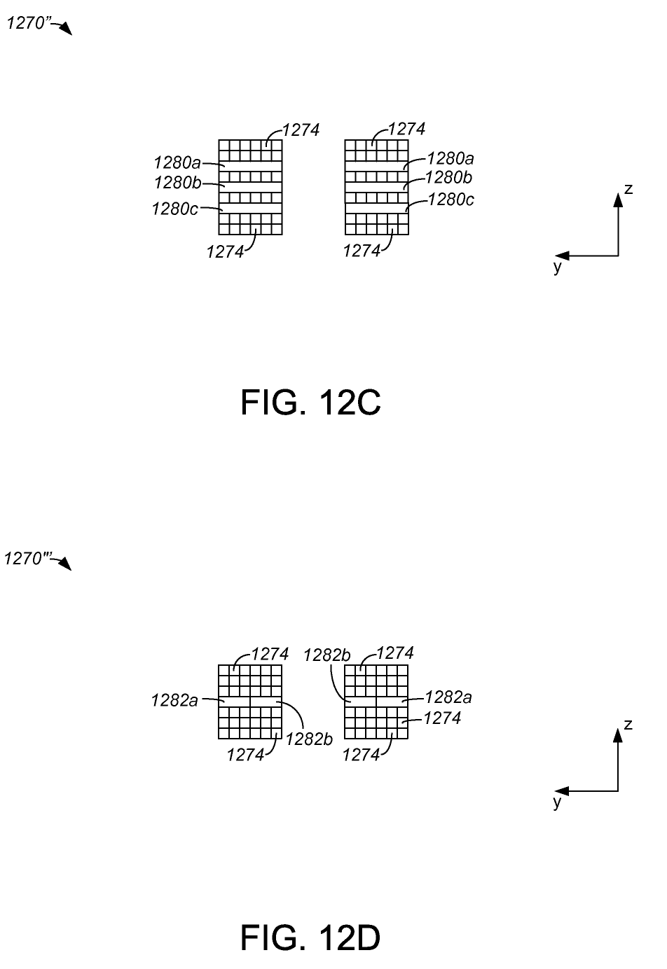

FIG. 12A is a diagrammatic perspective representation of a coil in accordance with an embodiment of the present invention. A coil 1270 may include wires (not shown) of a plurality of different geometries. In one embodiment, coil 1270 may include wires (not shown) of a first cross-sectional geometry as well as at least one wire with a second cross-sectional geometry, e.g., at least one wire that is substantially flat. A wire that is substantially flat, or a flat wire, may have a height that is substantially smaller than a width. The height or thickness of wire may be between approximately 25 micrometers and approximately 2000 micrometers.

A flat wire may be positioned at approximately a center of coil 1270. FIG. 12B is a diagrammatic cross-sectional representation of coil 1270 in which a flat wire is present in approximately a center of coil 1270 in accordance with an embodiment of the present invention. It should be appreciated that coil 1270′, as represented in FIG. 12B, is not to scale and has been exaggerated for purposes of illustration. Coil 1270′ includes first wires 1274 of a first geometry and a flat wire 1278. Although first wires 1274 are shown as having an approximately square cross-section, first wires 1274 are not limited to having approximately square cross-sections. In general, first wires 1274 each have substantially the same cross-sectional characteristics, e.g., areas and shapes.

Flat wire 1278 is located in an approximate center of coil 1270′. Flat wire 1278 effectively functions as a pathway for heat near a center of coil 1270′ to substantially distribute from the center of coil 1270′ to the sides of coil 1270′. Hence, the hottest region associated with coil 1270′ may be moved away from the center of coil 1270′. A peak temperature associated with coil 1270′ may also drop, e.g., may be lower than a peak temperature associated with a coil that does not include flat wire 1278 located in an approximate center of the coil.

In lieu of including a single flat wire 1278, it should be appreciated that any number of flat wires may generally be included in a coil. FIG. 12C a diagrammatic cross-sectional representation of a coil in which a plurality of flat wires is present in accordance with an embodiment of the present invention. It should be understood that the dimensions of a coil 1270″ are exaggerated, and are not drawn to scale. a Coil 1270″ includes first wires 1274 of a first geometry and a plurality of flat wires 1280a-c. When multiple flat wires 1280a-c are included in coil 1270″, heat may be distributed away from a center of coil 1270″, and a peak temperature in coil 1270″ may be reduced.

As shown in FIG. 12C, a plurality of flat wires 1278a-c may be arranged such that flat wires 1278a-c are each positioned as substantially separate layers within coil 1274. Alternatively, a plurality of flat wires may instead effectively be part of the same layer. FIG. 12D a diagrammatic cross-sectional representation of a coil in which a plurality of flat wires is oriented in a substantially single layer in accordance with an embodiment of the present invention. A coil 1270′″ includes first wires 1274 of a first geometry and a plurality of flat wires 1282a, 1282b that are oriented in a layer approximately near a center of coil 1270′″. The presence of flat wires 1282a, 1282b redistributes heat in coil 1270′ away from the center of coil 1270′″.

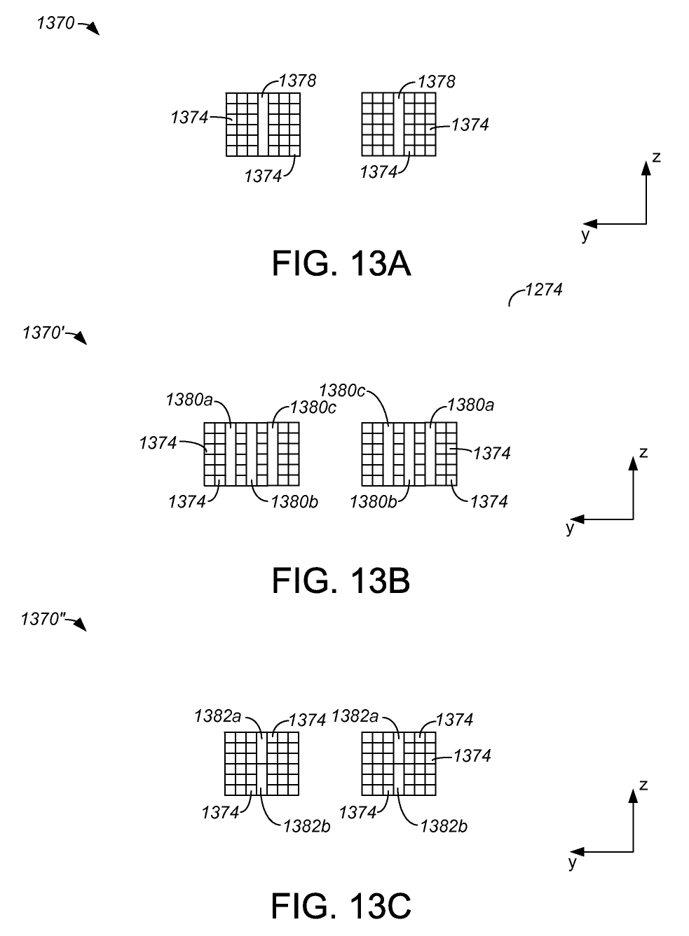

A flat wire may be added a coil as described above to remove and/or redistribute heat from the center, e.g., relatively hot, regions of the coil. The flat wires of FIGS. 12B-D have generally been shown as being oriented substantially horizontally within a coil It should be appreciated that a flat wire included in a coil is not limited to being oriented substantially horizontally. By way of example, a flat wire may be oriented substantially vertically within a coil. With reference to FIGS. 13A-C, coils which include at least one vertically oriented flat coil will be described in accordance with the present invention.

A flat wire oriented substantially vertically may be positioned at approximately a center of coil, e.g., coil 1270 of FIG. 12. FIG. 13A is a diagrammatic cross-sectional representation of a coil in which a flat wire is present in a vertical orientation in approximately a center of the coil in accordance with an embodiment of the present invention. It should be appreciated that a coil 1370, as represented in FIG. 13A, is not to scale and has been exaggerated for purposes of illustration. Coil 1370 includes first wires 1374 of a first geometry and a flat wire 1378. First wires 1374 are shown as having an approximately square cross-section. although first wires 1374 are not limited to having approximately square cross-sections.

Flat wire 1378 is located in an approximate center of coil 1370, and is substantially oriented along a z-axis. Flat wire 1378 effectively functions as a pathway for heat near a center of coil 1370 to substantially distribute from the center of coil 1370 to the sides of coil 1370. Thus, the hottest region associated with coil 1370 may be moved away from the center of coil 1370.

In lieu of including a single flat wire 1378 near center of coil 1370, it should be appreciated that any number of flat wires may generally be included in a coil. FIG. 13B is a diagrammatic cross-sectional representation of a coil in which a plurality of flat wires in a vertical orientation is present in accordance with one embodiment of the present invention. It should be appreciated that a coil 1370′, as represented in FIG. 13B, is not to scale and has been exaggerated for purposes of illustration. Coil 1370′ includes first wires 1374 of a first geometry and a plurality of flat wires 1380a-c. When multiple flat wires 1380a-c are included in coil 1370′, heat may be distributed away from a center of coil 1370′, and a peak temperature in coil 1370′ may be reduced.

Rather than arranging a plurality of flat wires in substantially separate layers of a coil, a plurality of flat wires may instead effectively be part of the same layer. FIG. 13C is a diagrammatic cross-sectional representation of a coil in which a plurality of flat wires in a stacked vertical orientation is present in accordance with one embodiment of the present invention. A coil 1370″ includes first wires 1374 of a first geometry and a plurality of flat wires 1382a, 1382b that are oriented in a layer approximately near a center of coil 1370″, and oriented substantially along a z-axis. The presence of flat wires 1382a, 1382b redistributes heat in coil 1370″ away from the center of coil 1370″.

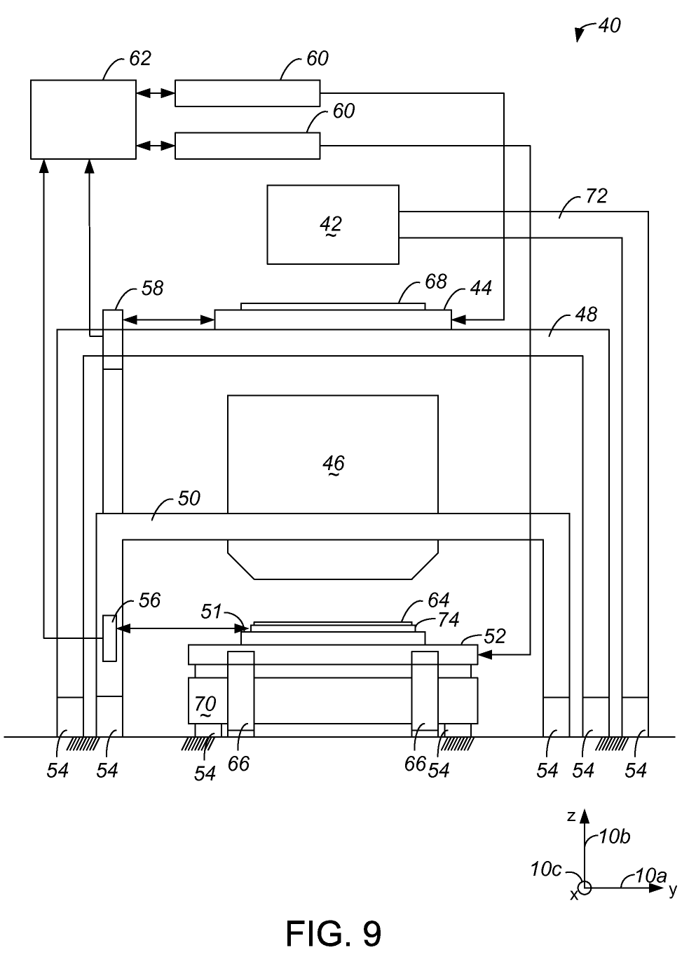

With reference to FIG. 9, a photolithography apparatus which may include an electromagnetic coil with a varying coil geometry, or an electromagnetic coil that includes a flat wire, will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an EI-core actuator with a top coil and a bottom coil which have varying coil geometries. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open patent applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave minor. Japan Patent Application Disclosure (Hei) No. 8-334695 published in the Official gazette for Laid-Open patent applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

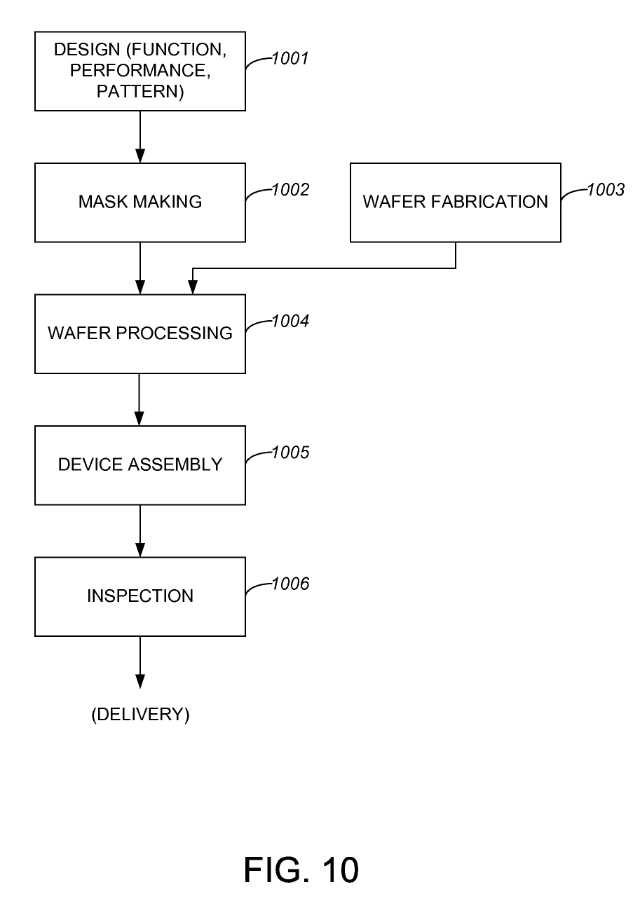

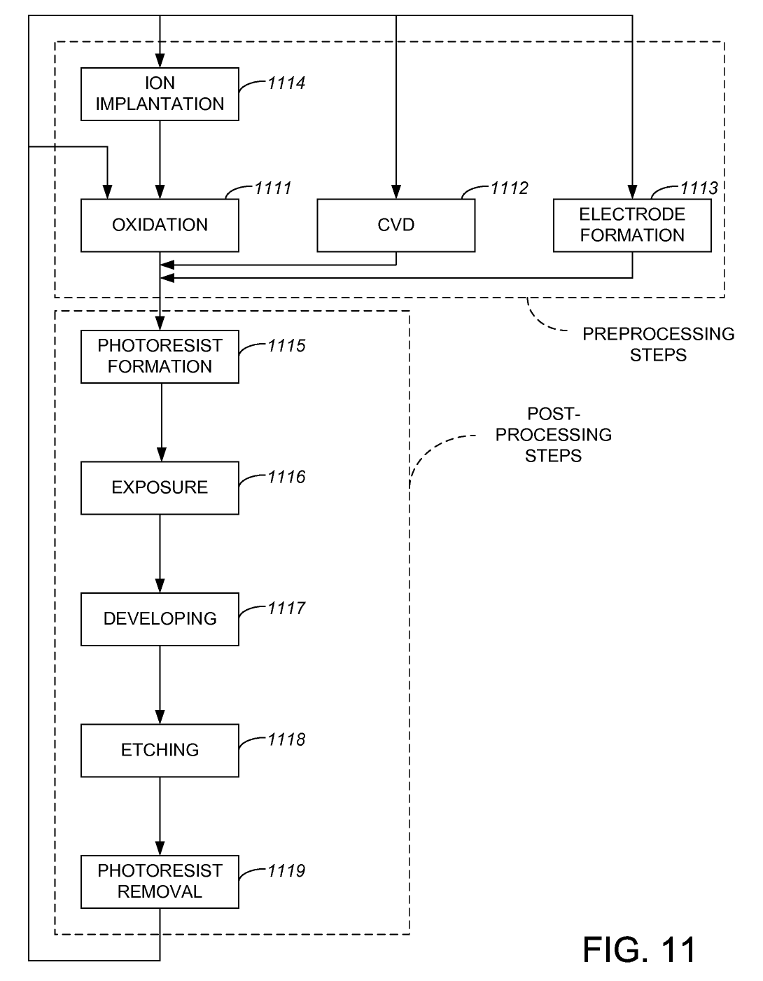

Further, semiconductor devices may be fabricated using systems described above, as will be discussed with reference to FIG. 10. FIG. 10 is a process flow diagram which illustrates the steps associated with fabricating a semiconductor device in accordance with an embodiment of the present invention. A process 1001 of fabricating a semiconductor device begins at step 1003 in which the function and performance characteristics of a semiconductor device are designed or otherwise determined. Next, in step 1005, a reticle or mask in which has a pattern is designed based upon the design of the semiconductor device. It should be appreciated that in a substantially parallel step 1009, a wafer is typically made from a silicon material. In step 1013, the mask pattern designed in step 1005 is exposed onto the wafer fabricated in step 1009. One process of exposing a mask pattern onto a wafer will be described below with respect to FIG. 11. In step 1017, the semiconductor device is assembled. The assembly of the semiconductor device generally includes, but is not limited to including, wafer dicing processes, bonding processes, and packaging processes. Finally, the completed device is inspected in step 1021. Upon successful completion of the inspection in step 1021, the completed device may be considered to be ready for delivery.

FIG. 11 is a process flow diagram which illustrates the steps associated with wafer processing in the case of fabricating semiconductor devices in accordance with an embodiment of the present invention. In step 1101, the surface of a wafer is oxidized. Then, in step 1105 which is a chemical vapor deposition (CVD) step in one embodiment, an insulation film may be formed on the wafer surface. Once the insulation film is formed, then in step 1109, electrodes are formed on the wafer by vapor deposition. Then, ions may be implanted in the wafer using substantially any suitable method in step 1113. As will be appreciated by those skilled in the art, steps 1101-1113 are generally considered to be preprocessing steps for wafers during wafer processing. Further, it should be understood that selections made in each step, e.g., the concentration of various chemicals to use in forming an insulation film in step 1105, may be made based upon processing requirements.

At each stage of wafer processing, when preprocessing steps have been completed, post-processing steps may be implemented. During post-processing, initially, in step 1117, photoresist is applied to a wafer. Then, in step 1121, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1125. Once the exposed wafer is developed, parts other than residual photoresist, e.g., the exposed material surface, may be removed by etching in step 1129. Finally, in step 1133, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while a coil has been described as being formed from an overall conductor wire with different geometries such that the amounts of heat generated at different regions of the coil may vary, it should be appreciated that a coil may instead be formed from an overall conductor wire with different materials. For example, an overall conductor wire may be formed from substantially any types of wire which have different resistances per unit length. It should be appreciated that such an overall conductor wire may also be arranged to be formed from wire components which have both different geometries and different materials. Further, in lieu of having different geometries, an overall conductor wire may instead be formed from different materials which have different characteristics.

The dimensions of coils, and the number of windings associated with a coil, may vary widely. It should be appreciated that such characteristics of a coil may vary based on any number of factors including, but not limited to including, the size of an actuator of which the coil is a part, the amount of force to be provided by the actuator, and the amount of current that is available.

A coil may be formed from an overall conductor wire which has any suitable cross-sectional shape. For example, a conductor wire may have a circularly-shaped cross-section, a rectangularly-shaped cross-section, and/or an irregularly-shaped cross-section.

Coils may be cooled internally as well as substantially on the outer surfaces of the coils, in one embodiment. In such cases, a coil may be configured according to the aspects of the invention, such that more heat is generated near regions where cooling is applied and less heat is generated in regions which are away from a cooling source. Therefore, the term “outer surface” as used above may, in one embodiment, refer to coil regions that are effectively cooled by applying cooling methods, while the term “region of a coil that is not near an outer surface” may refer to regions that are further away from a cooling source.

Generally, the total amount of heat generated in a section may be dependent at least in part upon the size of that section, e.g., a length of the conductor in that section. As such, in a case where the length or “amount” of conductor in a first section may is much lower than the length or “amount” of conductor in a second section, although the heat generated per unit length of conductor in the second section may be lower than that of the first section, the total heat in the second section may be larger than that of the first section. Hence, an amount of heat generated per unit volume of the first section may be greater than the second amount of heat generated per unit volume of the second section.

In lieu of adding flat wires to coils, certain layers in a coil may be substantially replaced by flat wire such that the overall dimension of a coil remains approximately the same. Further, rather than using flat wires in coils, flat thermally conductive plates may instead be used to substantially redistribute heat within the coils. For example, flat wires as shown in FIGS. 12B-D may instead be flat thermally conductive plates.

The operations associated with the various methods of the present invention may vary widely. By way of example, steps may be added, removed, altered, combined, and reordered without departing from the spirit or the scope of the present invention.

The many features of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. An electromagnetic actuator comprising:
a core; and
a coil, the coil being formed from a conductor wire that includes a plurality of windings, the plurality of windings being arranged around the core, the plurality of windings including at least a first set of windings and a second set of windings, wherein the first set of windings has a different geometry from the second set of windings.

2. The electromagnetic actuator of claim 1 wherein the first set of windings is located at approximately a first outer section of the coil and the second set of windings is located at approximately a center section of the coil, and wherein the first set of windings has a first cross-sectional area and the second set of windings has a second cross-sectional area, the first cross-sectional area being smaller than the second cross-sectional area.

3. The electromagnetic actuator of claim 2 wherein the plurality of windings further includes at least a third set of windings, the third set of windings being located at approximately a second outer section of the coil, and wherein the third set of windings has approximately the first cross-sectional area.

4. The electromagnetic actuator of claim 3 wherein the first outer section of the coil is a top section of the coil and the second outer section of the coil is a bottom of the coil.

5. The electromagnetic actuator of claim 1 wherein the first set of windings has a lower resistance per unit length than the second set of windings.

6. The electromagnetic actuator of claim 1 wherein the first set of windings is soldered to the second set of windings.

7. The electromagnetic actuator of claim 1 wherein the coil is a copper coil.

8. The electromagnetic actuator of claim 1 wherein the conductor wire is one selected from a group including a flat wire and a flat thermally conductive plate.

9. A stage apparatus comprising the electromagnetic actuator of claim 1

10. An exposure apparatus comprising the electromagnetic actuator of claim 9.

11. A wafer formed using the apparatus of claim 10.

12. An electromagnetic actuator comprising:
a core;
a current input, the current input being arranged to provide an overall current flow; and
a coil, the coil being formed form a conductor wire that includes a plurality of windings, the plurality of windings being arranged around the core, the plurality of windings including at least a first set of windings and a second set of windings, wherein the overall current flow flows through the coil such that a first amount of heat is generated in the first set of windings and a second amount of heat is generated in the second set of windings, the first amount of heat generated being greater than the second amount of heat when the first amount of heat is measured per unit volume of the first section and the second amount of heat is measured per unit volume of the second section.

13. The electromagnetic actuator of claim 12 wherein the second set of windings includes a first sub-section and a second sub-section, the first sub-section and the second sub-section being connected substantially in parallel, and wherein the first set of windings is coupled to the first sub-section and to the second sub-section such that a first amount of the overall current flow flows from the first set of windings into the first sub-section and a second amount of the overall current flow flows into the second sub-section substantially simultaneously.

14. The electromagnetic actuator of claim 13 wherein the overall current flow has a first value, and the first amount of the overall current flow is approximately one-half of the first value.

15. The electromagnetic actuator of claim 13 wherein the plurality of windings further includes a third set of windings, the third set of windings being connected to the first sub-section and to the second sub-section such that the first amount of the overall current flow flows from the first sub-section to the third set of windings and the second amount of the overall current flow flows from the second sub-section to the third set of windings.

16. The electromagnetic actuator of claim 15 wherein the first set of windings is located approximately at a top of the coil, the third set of windings is located approximately at a bottom of the coil, and the second set of windings is located approximately at a center region of the coil between the first set of windings and the third set of windings.

17. The electromagnetic actuator of claim 12 wherein the coil is a copper coil.

18. A stage apparatus comprising the electromagnetic actuator of claim 12.

19. An exposure apparatus comprising the electromagnetic actuator of claim 18.

20. A wafer formed using the apparatus of claim 19.

21. A method for operating an electromagnetic actuator, the electromagnetic actuator including a coil, the coil having at least a first section and a second section, the method comprising:
providing a current to the coil, wherein providing the current to the coil causes a first amount of heat to be generated in the first section and a second amount of heat to be generated in the second section, the second amount of heat being less than the first amount of heat when the first amount of heat is measured per unit volume of the first section and the second amount of heat is measured per unit volume of the second section; and
cooling the first section, wherein cooling the first section includes removing at least some of the first amount of heat.

22. The method of claim 21 wherein the second section includes a first sub-section and a second sub-section, and wherein providing the current to the coil includes providing a first amount of the current to the first section and providing approximately half of the first amount of the current substantially simultaneously to the first sub-section and the second sub-section.

23. The method of claim 21 wherein the coil further includes a third section, the first section being a top section of the coil, the second section being approximately a center section of the coil, and the third section being a bottom section of the coil.

24. The method of claim 23 wherein providing the current to the coil includes first providing the current to the first section, and wherein providing the current to the coil causes a third amount of heat to be generated in the third section, the third amount of heat being more than the second amount of heat.

25. The method of claim 24 further including:
cooling the third section, wherein cooling the third section includes removing at least some of the third amount of heat.

26. The method of claim 24 wherein the first section and the third section includes coil windings of a first geometry, and wherein the second section includes coil windings of a second geometry, the second geometry having a lower resistance per unit length than the first geometry.

27. The method of claim 21 wherein the first section includes a first set of coil windings and the second section includes a second set of coil windings, the first set of coil windings having a higher resistance per unit length than the second set of coil windings.
